(19) United States
(12) Patent Application Publication
(10) Pub. No.: US 2021/0319188 A1
(43) Pub. Date: Oct. 14, 2021

(54) DEVICE AND METHOD FOR GENERATING LANGUAGE

(71) Applicant: HUAWEI TECHNOLOGIES CO., LTD., Shenzhen (CN)

(72) Inventors: Giulio ZHOU, London (GB); Gerasimos LAMPOURAS, London (GB)

(73) Assignee: HUAWEI TECHNOLOGIES CO., LTD., Shenzhen (CN)

(21) Appl. No.: 17/225,364

(22) Filed: Apr. 8, 2021

Related U.S. Application Data
(63) Continuation of application No. PCT/EP2020/059948, filed on Apr. 8, 2020.

(51) Int. Cl. G06F 40/40; G06F 40/30; G06F 40/253; G06F 40/289; G06N 20/00

(52) U.S. Cl. CPC G06F 40/40; G06F 40/30; G06N 3/08; G06F 40/289; G06N 20/00; G06F 40/253

(57) ABSTRACT

A device including a selection module for use in generating a natural language output based on a computer readable input, the selection module including: a classifier module, where the classifier module is trained such that when executed alongside a language generation logic, the classifier module executes the steps of: receiving one of one or more candidate words of a probability distribution and a current state of a decoder in a recurrent decoding process of the language generation logic; evaluating, based on the current state of the decoder, the received candidate word to determine if the word is likely to lead to a grammatically correct output; assigning a numerical value indicative of a level of grammatical correctness to the received candidate word; and outputting the assigned numerical value.

### CROSS-REFERENCE TO RELATED APPLICATIONS

This application is a continuation of International Application No. PCT/EP2020/059948, filed on Apr. 8, 2020, the disclosure of which is hereby incorporated by reference in its entirety.

### TECHNICAL FIELD

The embodiments relate to generating language using artificial intelligence models.

### BACKGROUND

Language generation, for example natural language generation (NLG), is a family of tasks with the goal of generating a language text from a specified input. The input can be machine-readable semantic representation, a graph, a set of database entries, or another natural language text. Neural models are very popular for language generation tasks, but they tend to produce repetitive outputs in terms of lexical choice and structure.

Neural NLG models usually employ an encoder-decoder architecture: the input is encoded in a vector representation, and then is fed to a recurrent decoder that sequentially constructs the output. Typical methods which promote output diversity in neural NLG models (i.e. artificial intelligence models or neural networks for generating varied language outputs), fit into the following two major categories.

The first category entails altering or augmenting the input to the encoder of the NLG model, for example by varying the weights by which the input is encoded, under the assumption that a diverse input will lead to a diverse output.

In one approach a diverse output is produced by augmenting the input encoding with diversity-specific information through Conditional Variational Autoencoders [Zhao et al. (2017)]. Going further with modifying the encoding, another approach includes reshaping the whole embedding space of the input, with the reasoning that a more structured latent space leads to more diverse output [Gao et al. (2019)]. Yet another approach proposes “forcing” the output of the first decoding step, arguing that greedy inference from different starting points will lead to diverse but fluent sentences [Deriu and Cieliebak (2017)]. This was achieved by augmenting the input to bias the first step of the decoding process towards particular words observed in the data. However, the application of this method is limited to the first decoding step.

The second category includes different strategies for choosing words from the probability distributions calculated by the recurrent decoder.

The most commonly used decoding strategy to promote diverse output is beam search, but it has limited success. Instead one approach proposes mutual information maximization as a diversity focused objective function used during decoding [Li et al. (2016)], while another approach tackles this via adversarial learning [Zhang et al. (2018)]. In more complex decoding strategies for diversity, it is possible to limit the decoder distribution to a fixed number of the top-k words (Top-k sampling) [Fan et al. (2018)]. While a similar approach limits the distribution to the smallest subset of words whose cumulative probability does not exceed a predefined parameter p, referred to as Nucleus sampling [Holtzman et al. (2019)]. Nucleus sampling improves over Top-k by retaining a dynamic number of words per decoding step, but the probability mass p remains a constant parameter.

Most of the above methods mainly focus on promoting semantic diversity, and are incompatible with language generation tasks where the output semantics are strictly bounded by the input, for example concept-to-text generation, machine translation, etc. Additionally, many existing methods are controlled using parameters for which there is no established methodology for tuning such that the output quality and diversity is balanced. As a result, configuring these systems around such parameters become a manual trial and error process. Examples of such parameters in the above-mentioned approaches are the k in Top-k sampling and the p in Nucleus sampling.

As mentioned above, natural language generation is the family of tasks where the goal is to generate a natural language text. NLG can be treated as a structured prediction problem where every action results in a word. A problem with existing machine learning algorithms deployed in language generation is that they often generate particular lexical structures with the same lexical elements for a given input signal. That is, the dialogue systems get repetitive, boring, and inhuman. Previous approaches to increase variety include limiting or reranking the learned word distributions of the language generation model. That is, different strategies on how to sample from the output word distribution.

It is desirable to develop an approach which allows for sampling between possible decoder outputs in a way that does not over specify the output and as such allows for a degree of randomness or freedom. That is, an approach is desired which minimises the repetitive nature of the output of previous methods, but also which imposes a structure on the output so as to maintain a good quality of output without a need for any system or context specific parameters.

### SUMMARY

According to one aspect there is provided a device including a selection module for use in generating a natural language output based on a computer readable input, the selection module including: a classifier module, where the classifier module is trained such that when executed alongside a language generation logic the classifier module executes the steps of: receiving one of one or more candidate words of a probability distribution and a current state of a decoder in a recurrent decoding process of the language generation logic; evaluating, based on the current state of the decoder, the received candidate word to determine if the word is likely to lead to a grammatically correct output; assigning a numerical value indicative of a level of grammatical correctness to the received candidate word; and outputting the assigned numerical value.

The selection module may include a candidate module, the candidate module may be configured to: receive the current state and the one or more candidate words of the probability distribution of the decoder in the recurrent decoding process of the language generation logic; feed, separately, each of the one or more candidate words to the classifier module; and create a vector of acceptable words including each of the candidate words to which the classifier module assigned a numerical value indicative of a level of acceptable grammatical correctness. This may allow for a more efficient process at the classifier module, e.g. efficient transfer of data to the classifier module and reduced processing cost at the classifier module.

The candidate module may be configured to output the vector of acceptable words to the language generation logic such that only one of the one or more candidate words which also has a high probability of leading to a sensical sentence is chosen at each step of the recurrent decoding process. This may allow for the selection module to provide an output to the decoder which imitates the output the decoder itself would typically provide, facilitating a seamless connection between the selection module and the language generator logic.

The candidate module may feed the each one of the one or more candidate words to the classifier module in order of descending probability. This may allow for the language generator logic's embedded selection criteria to be accounted for in the output of the selection module.

The candidate module may stop feeding the one or more candidate words to the classifier module if the classifier module outputs one of the candidate words with an assigned numerical value indicating a level of unacceptable grammatical correctness. This may provide an efficient selection mechanism which automatically discounts processing of lower quality candidate words.

The language generation logic may select the candidate word for the next current state of the decoder by sampling from the vector of acceptable words. This may provide a balanced selection from the acceptable words.

The language generation logic may be Natural Language Generator logic where the output is a string of words forming an utterance expressing the input in natural language. The Natural Language Generator logic may include at least one of concept-to-text, context-to-text, or text-to-text Natural Language Generator logic. This may enable the process to provide an effective solution to many common types of language tasks.

Each word of the candidate words may be defined for input to the classifier module according to the equation:

c=[hₜ,tan h(W_{dc}dₜ),W_{wr}xₜ₊₁ⁱ,W_{wr}xₜ₋₂,W_{wr}xₜ₋₁,W_{wr}xₜ],
where W_{wr} is a word embedding weight matrix, W_{dc} is the input representation weight matrix, xₜ is the word at step t, hₜ is the hidden state of the decoder at step t, dₜ is the input vector representation, and xₜ₊₁ⁱ is the i-th word of the decoding distribution for the next step t+1. This may allow for an efficient way of representing each of the candidate words to the classifier module.

The numerical value indicative of a level of grammatical correctness may be selected from 1 or 0, where 1 indicates an acceptable level and 0 indicates an unacceptable level. This may provide an efficient representation of the evaluation made by the classifier module.

According to a second aspect there is provided a method of training a classifier module including a trained artificial intelligence model for execution alongside a language generation logic such that a word with a high probability of leading to a sensical sentence is chosen at each decoder step of a recurrent decoding process of the language generation logic, the method including: receiving an example candidate word of a probability distribution of one decoder step of said language generation logic; and training the classifier module using imitation learning, based on the example candidate word and either an expert policy configured to identify words which have a high probability of leading to sensical sentences or the classifier module when partially trained, to determine the likelihood a candidate word will lead to a sentence which has an acceptable level of grammatical correctness and to assigning a numerical value to the candidate word indicative of the level of grammatical correctness.

The imitation learning framework may include at least one of LOLS, Dagger, SEARN, Exact Imitation. This may provide an efficient training mechanism for training the classifier module for tasks involving generating language.

According to a third aspect there is provided a method of creating an expert policy configured to identify candidate words of a probability distribution which have a high probability of leading to grammatically correct outputs from a language generation logic, the method including: receiving a set of the candidate words in order of selection strength; forming, by use of pre-emptive decoding for each candidate word of the set, a candidate phrase including lexical elements appropriate to accompany that candidate word of the set; and assigning to each candidate word of the set a value indicative of a level of grammatical correctness in dependence on the relative selection strength of that candidate word and the fit of the respective candidate phrase to members of a database of valid phrases.

The value assigned to the candidate word may be one of: 0 if the fit of the candidate phrase formed for said candidate word is worse than any preceding candidate word in the set; or 1 and if the fit of the candidate phrase formed for said candidate word is better than any preceding candidate word in the set. This may provide an efficient way of outputting the expert opinion of the expert policy for consideration by the classifier module.

The fit may be measured using an n-gram precision calculation. This may provide an efficient mechanism for evaluating candidate phrases.

### BRIEF DESCRIPTION OF THE FIGURES

The embodiments will now be described by way of example with reference to the accompanying drawings. In the drawings:

FIG. 1A shows an example recurrent decoding process and the diversity exhibited by a trained language generation model;

FIG. 1B shows an example recurrent decoding process and the diversity exhibited by a trained language generation model;

FIG. 2 shows a standard encoder-decoder language generation architecture with the proposed selection module deployed on top of each decoder cycle;

FIG. 3 shows a more detailed view of the selection module and how it connects to the underlying language generation model;

FIG. 4 shows a table illustrating an expert policy inferring a specific training signal from a data set for grammatically correct and fluent phrases; and

FIG. 5 shows a comparison between the output of the proposed approach and the output of an existing approach when given the same input.

### DETAILED DESCRIPTION OF THE EMBODIMENTS

The proposed approach focuses on promoting safe diversity; that is, using words that lead to diverse output but are not liable to also lead to disfluent word sequences. This is achieved by a selection module, including a classifier module, provided on top of the decoding process. The classifier module is trained by exploiting a diversity-specific training signal to determine which words in the decoding distribution will lead to safe diversity. The diversity-specific training signal is obtained from an expert policy through imitation learning frameworks.

The proposed approach enables a language generation logic to exploit a data set of multiple references to introduce variety which will lead to grammatically correct outputs. The above discussed existing approaches do not utilise any grammatical or sensical-specific training signals. Additionally, they do not take into account how a word choice will impact the rest of the sentence.

The aim of the proposed approach is to promote lexical and structural diversity in the output, so that its quality, including elements like fluency and grammatical correctness, etc., do not suffer when achieving high diversity. The proposed approach includes a classifier module including an artificial intelligence model which is applied on top of the decoder during a recurrent decoding process of a natural language generator (NLG). The selection module thus considers the current state and output word distribution of the recurrent decoder and determines which words will lead to safely diverse outputs. The term safe diversity may be defined as promoting the use of words that lead to a diverse output but are additionally not liable to also lead to disfluent word sequences through error propagation. The proposed approach thus encourages NLG neural models to produce more diverse output, the output may more freely select from a range of diverse structures and lexical choices, by first applying a classifier across a range of potential diverse outputs. The proposed approach is therefore more closely related to the above described second category of methods for promoting diversity.

Further, the proposed approach provides a device including a selection module for use in generating a natural language output based on a computer readable input. That is, a selection module is provided which can be applied during processes in which language is generated by a computer for the purposes of communicating computer readable information to a user. The selection module includes a classifier module. The classifier module may be referred to as an artificial intelligence model which has been trained such that when executed alongside such a language generation logic the classifier module determines if a word is an appropriate next word in the sentence. This is determined via a plurality of steps including receiving one of one or more candidate words of a probability distribution and a current state of a decoder in a recurrent decoding process of the language generation logic. The received candidate word is then evaluated based on the current state of the decoder to determine if the word is likely to lead to a grammatically correct output. That is, will a probable output statement, in which the candidate word follows the current word, make sense. This may include a consideration of the context of the input. Next, the received candidate word is assigned a numerical value indicative of a level of grammatical correctness in response the evaluation. Finally, the assigned numerical value is output. The output numerical value may be accompanied by the candidate word to which it was assigned.

The language generation logic may be NLG logic where the output is a string of words forming an utterance expressing the input in natural language. However, any language generator logic may incorporate the proposed approach for selecting appropriate words from a decoder probability distribution. The language generation logic may be referred to as a language generation model or language generation artificial intelligence module. In the example implementation described below this logic is a concept-to-text NLG logic or model. However, this is only an example of a language generation logic to which the proposed approach may be applied, and other language generation logics with recurring decoder cycles may also be appropriate for applying such an approach.

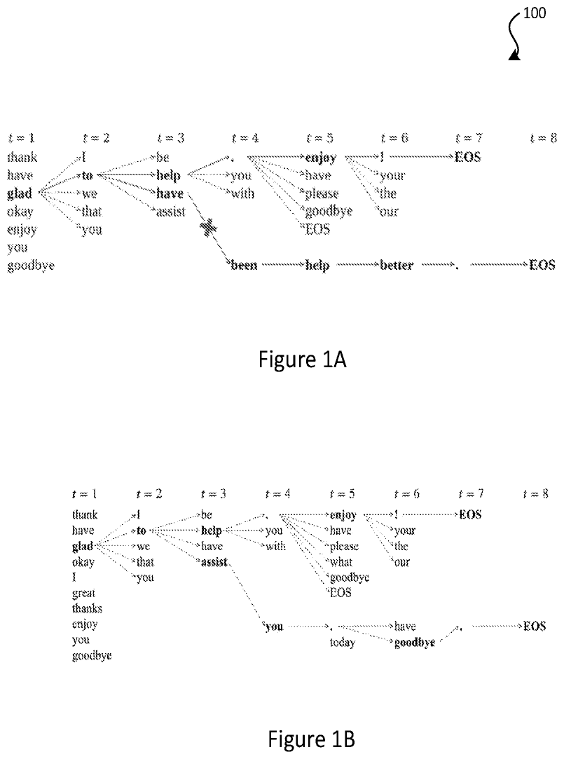

FIGS. 1A and 1B show an example recurrent decoding process and the diversity exhibited by a trained language generation model or, for example, an NLG. The language generator model constructs a text by decoding one word at a time. At each step of the process the distribution that results from the recurrent decoder is examined and a word is chosen accordingly. The words are shown in descending probability as determined by the model. However, only a subset of words in the vocabulary will lead to quality sequences, i.e. sentences which are grammatically correct and which make sense.

For example, as shown in FIG. 1A at t=3, choosing the word “help” is a valid and sensible choice leading to the output “glad to . . . help. Enjoy!”. “help” is high up in the list of candidate words and therefore the NLG has determined that it has a high probability of being the next word given the syntax history.

Similarly, as shown in FIG. 1A at t=3, choosing the word “have” seems like a sensible choice given the history. This is also only the next word down from “help” in the probability distribution provided by the NLG. One can imagine that this word may lead to an output like “glad to have been of help!” Unfortunately, due to the language generator model being imperfect, this choice leads to the disfluent output “glad to . . . have been help better”.

On the other hand, as shown in FIG. 1B, the word “assist” would be assumed to lead to an even worse output than “have” as according to the language generation model it has a lower probability of being the next word given the syntax history than “have”. However, the choice of the word “assist” provides a more sensical and fluent output than “have”. This is because “assist” leads to the same selection branch as “help”, and thus to a fluent output.

It can be seen from this example that selecting based on the NLG probability ranked output alone does not guarantee a corresponding level of grammatical correctness in the final output. The presently proposed method uses a trained artificial intelligence model to distinguish that choosing “have” will not lead to safe diversity, while choosing “help” will.

However, there is no existing data set explicitly annotated for the safe diversity referred to above. Thus, there is also a need to provide the data which can be used to train the AI model of the classifier module. In order to address this, it has been devised that an expert policy can be created. The expert policy can infer which words lead to safe diversity based on what the NLG model can produce without negatively affecting the output text's quality. That is, the expert policy can infer which of the words output as candidate words by the NLG are safe to select in order to result in a sensical and grammatically correct output while also being lexically diverse or varied. This may be executed by using imitation learning frameworks which can be employed to obtain a training signal from the expert policy for training the classifier module. Imitation learning is a family of meta-learning frameworks designed to train models based on expert demonstrations. In this case the expert demonstration comes from the expert policy.

The proposed implementation of the described method is orthogonal to the architecture of an underlying NLG encoder-decoder model. The proposed method as described herein assumes that the NLG is pretrained. This means that the described selection module can be applied to any language generation model as long as the final text is generated through a recurrent decoding process. However, it should be understood that the NLG being pretrained is an example of the state of the NLG. The NLG could be trained immediately before applying the orthogonal selection module, or potentially trained in parallel while training the classifier module of the selection module and thus being assembled as though one contiguous system.

The proposed approach will now be described in relation to an example implementation. The example implementation concerns concept-to-text NLG, where the input is a machine-readable meaning representation (MR) and the output is a string of words which form an utterance expressing the input in natural language. It should be understood that the proposed approach could be applied to other types of NLG other than concept-to-text. For example, context-to-text or text-to-text generation which may be used for tasks such as paraphrasing, summarization, and machine translation, among other language based tasks.

There is no standard for how MRs are represented or even what information they need to contain. The present approach is able to function independently of these particulars of the MR. For this described example implementation, it is assumed that the input MR is formed of one or more predicates; each predicate having a set of attributes and corresponding values. The predicate dictates the communication goal of the output text, while attributes and values dictate the content.

The example MR of [INFORM (REST-NAME=MIZUSHI, OKASAN)] denotes that the output of the NLG model should inform the user of two restaurants called “Mizushi” and “Okasan”. There are many acceptable outputs for the same MR, each exhibiting a different lexical and structural way to express the same semantic content. Concept-to-text data sets usually provide multiple output references per MR. For the above example MR, output references could include “There are two available restaurants, Mizushi and Okasan” or “Mizushi is an available restaurant nearby. Okasan is another one”.

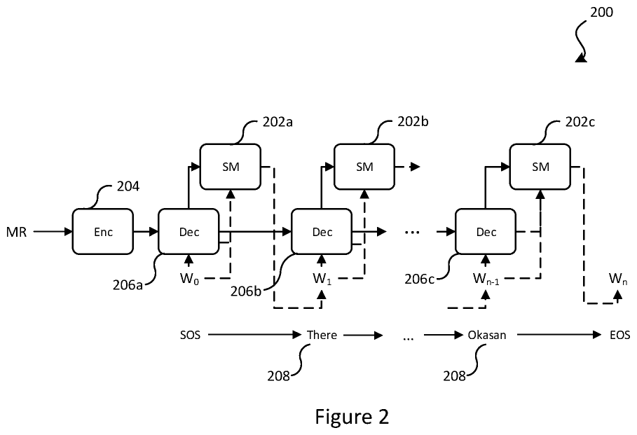

FIG. 2 shows a standard encoder-decoder language generation architecture 200 with the proposed selection module 202 deployed on top of each decoder cycle. The input MR is encoded as a vector representation at an encoder 204 and is then fed into a decoder sequence. The current state 208 of the decoder as selected during the previous cycle is shown underneath each respective decoder module 206.

NLG may be treated as a structured prediction problem, where the output is a string of words constructed via sequential decoding. That is, every word may be emitted based on the probability distribution calculated by a decoder cell 206. Decoder cells 206a-c are arranged sequentially, with the output of the previous step being fed to the next step as an input until the end of the sentence is reached. Each sentence typically starts with the special start token Wₒ=“SOS” and ends with the special end token “EOS”.

The classifier artificial intelligence model of the proposed method is applied on top of the decoder sequence as part of the selection module 202. As mentioned above, the proposed method may be applied to any language generation machine learning model as long as the final text of the language generation model or logic is sequentially generated through choosing words from a probability distribution at each decoder step.

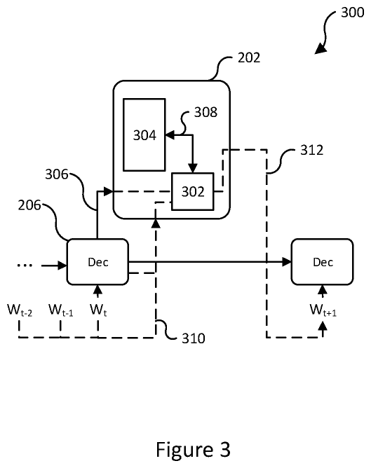

FIG. 3 shows a more detailed view of the selection module 202 and how it connects to the underlying NLG model.

The selection module 202 includes a candidate module 302 and a classifier module 304. The classifier module 304 learns to distinguish which words in the decoder probability distribution lead to safe diversity. The classifier module 304 is designed as a simple feed-forward neural network composed of alternative linear and ReLU layers ending with a softmax function. For example, three linear ReLU layers may be used with the hidden state size set to 512, trained through stochastic gradient descent and a learning rate of 0.05. This particular architecture and these example parameters are only specific to this example implementation and the overall method and implementation is not restricted to this example.

In FIG. 3 various lines show the different connections between the selection module 202 and the underlying NLG model. The probability distribution of the current decoder cycle Wₜ₊₁ is fed via connection 306 from the decoder 206 to the selection module 202. The probability distribution includes the candidate words for that decoder cycle Wₜ₊₁, from Wₜ₊₁ⁱ to Wₜ₊₁ⁿ. The selection module 202 also receives the current state of the decoder cycle Wt via connection 310. That is, the word selected from the probability distribution as a result of the previous decoder cycle Wt.

The candidate module 302 receives the candidate words xₜ₊₁ⁱ of the distribution in priority order and feeds each word of the probability distribution one at a time via connection 206 to the classifier module 304. This is in addition to the current state of the decoder, which is also provided to the classifier module.

The classifier module 304 then evaluates each of the one or more received candidate words in priority order to determine whether the word is likely to lead to a grammatically correct output, and assigns a numerical value indicative of the level of grammatical correctness likely to be achieved by using that candidate word.

The role of the classifier module 304 is to determine whether a specific word will lead to a valid output, i.e. an output which is grammatically correct and sensical. The candidate module could be defined as a component that iteratively calls the meta-classifier by feeding it one word, and optionally the current state, at a time. If the classifier module 304 considers the candidate word to be a valid choice (e.g. a word which is likely to lead to a valid output), the candidate module 302 may add this candidate word to an output set or list of valid candidate words. This procedure may stop once the candidate module reaches the first unacceptable word. That is, the process of creating the vector of acceptable words stops once the first candidate word which is assigned a 0 is reached. In this particular example the variety is limited to only ‘favourite’ and ‘personal’ as acceptable candidate words. However, this does not mean that there will only be two candidate sentences. For example, after choosing “favourite”, at the next decoder cycle there may be five different candidate words to choose from. This may be seen from the example shown in FIG. 1. By exploring all the possible paths which result from selecting from the candidate words, a multitude of different and equally valid sentences could become the final output. The candidate module 302 may supply the candidate words in decreasing probability order according to the original probability distribution of the language generation logic.

It should be noted that candidate words are evaluated on how likely they are to lead to a grammatically correct and sensical output, and not based on the likelihood of producing a lexically varied output. The variety of the output is achieved automatically, as the more candidate words which are indicated as valid, i.e. that can lead to a valid output, the more words which can be freely selected from by the language generation logic while maintaining a high quality output.

The classifier module considers each word in the NLG model vocabulary individually; the following equation defines the input c for each word:

c=[hₜ,tan h(W_{dc}dₜ),W_{wr}xₜ₊₁ⁱ,W_{wr}xₜ₋₂,W_{wr}xₜ₋₁,W_{wr}xₜ],

where W_{wr} is a word embedding weight matrix, W_{dc} is the input representation weight matrix, xₜ is the word at step t, hₜ is the hidden state of the decoder at step t, dₜ is the input vector representation, and xₜ₊₁ⁱ is the i-th word of the decoding distribution for the next step t+1. All the components of the input c may be retrieved as the selection module 202 may be pretrained to obtain them from the underlying NLG model.

The candidate word xₜ₊₁ⁱ and the numerical value are then output from the classifier module 304 to the candidate module 302.

The output of the classifier module for each word may be a probability distribution over two values. For example, the two values may be 0 and 1, with 1 denoting that the word is determined to be likely to lead to a grammatically correct output, and 0 denoting that the word is unlikely to lead to a grammatically correct output. From the classifier module's collective output for all candidate words there can be inferred a vocabulary-length binary vector B. The vector B may include all of the words output by the classifier module 304 with the numerical value 1, i.e. those words determined to be likely to lead to a grammatically correct output.

In the present example the classifier module may only output the numerical value it assigns to the candidate word and not the word itself. The candidate module may then correlate the numerical value to the candidate word identified as having been the candidate word most recently fed to the classifier module. The numerical value may be selected from 1 or 0. In another example of the described method the candidate module may receive not only the numerical value assigned to the input word from the classifier module but also the candidate word itself.

The candidate module 302 may then create the vector B of acceptable words which includes each of the candidate words to which the classifier module assigned a numerical value indicative of a level of acceptable grammatical correctness. For example, the vector B of acceptable candidate words may include all the candidate words which were assigned a numerical value of 1. It should be understood that more than two numerical values may be used in classifying the words fed to the classifier module. For example, 1 may denote a word with an acceptable but low likelihood of resulting in a grammatically correct output, whereas a numerical value of 2 may denote a word with an acceptable but high likelihood of resulting in a grammatically correct output. The boundary between a high and low likelihood may be determined based on the level of grammatical correctness the classifier module is designed to impose.

The candidate module may be configured to carry out specific steps including receiving the current state and the one or more candidate words of the probability distribution of the decoder in the recurrent decoding process of the language generation logic and then feeding each one of the one or more candidate words separately to the classifier module. That is, the classifier module may be provided with one candidate word from the distribution to evaluate, followed separately by a further candidate word from the distribution. Finally, the candidate module may create a vector of acceptable words including each of the candidate words to which the classifier module assigned a numerical value indicative of a level of acceptable grammatical correctness. The NLG may then select form the vector only one of the one or more candidate words which also has a high probability of leading to a sensical sentence and this may be repeated at each step of the recurrent decoding process.

In order to consider the NLG decoder's initial probability distribution when choosing a word the candidate module 302 may only sample from amongst the top consecutive words in vector B which were also assigned a non-zero probability by the decoder. That is, the candidate module may create a reduced vector B which is truncated to remove the least likely words according to the NLG probability distribution. The candidate module may also feed the candidate words to the classifier module in order of descending probability.

The candidate module 302 may then output the vector B of acceptable words to the language generation logic, for example via connection 312, such that only a candidate word which also has a high probability of leading to a sensical sentence is chosen at each step of the recurrent decoding process. That is, in this way the next decoder cycle is provided with a list of candidate words which have been determined to all be likely to lead to grammatically correct outputs. Sampling from this vector B of acceptable words may then be done in a way which provides a lexically varied output. That is, if the same input is provided to the NLG, and the same probability distribution is produced, as a result of classifying these candidate words based on their likelihood to lead to grammatically correct outputs, a different candidate word may confidently be selected from the created vector each time, even if the same input is provided. The NLG can provide a plurality of outputs which are both grammatically correct and lexically varied.

The above described method is applied at every decoding step over the decoder cell when implementing the language generation logic.

In additional or alternative implementations, the candidate module may stop feeding the one or more candidate words to the classifier module if the classifier module outputs one of the candidate words with an assigned numerical value indicating a level of unacceptable grammatical correctness. That is, the process of feeding candidate words to the classifier module for evaluation may stop when the most recent word is determined by the classifier module to be a candidate word which is not appropriate and subsequently assigns it a numerical value indicative of this determination.

The classifier module includes a trained artificial intelligence model for execution alongside a language generation logic. The classifier module may be trained such that a word with a high probability of leading to a sensical sentence may be chosen at each decoder step of a recurrent decoding process of the language generation logic.

However, training the classifier module 304 is difficult because specific labels for grammatically correct words in given contextual situations are not explicitly available in an existing training data set. Therefore, to obtain a relevant training signal an expert policy may be employed which infers which words lead to grammatically correct outputs. The expert policy may consider the relevancy of the output when determining the appropriateness of each output during training the classifier module. Imitation learning approaches may then be used to mimic the expert policy. Imitation learning is a family of meta-learning frameworks designed to train models based on expert demonstrations.

Therefore, a method of training the classifier module may include receiving an example candidate word of a probability distribution of one decoder step of a language generation logic. The classifier module can then be trained using imitation learning to determine the likelihood that a candidate word will lead to a sentence which has an acceptable level of grammatical correctness and to assigning a numerical value to the candidate word indicative of the level of grammatical correctness. This training is based on the example candidate word and either an expert policy configured to identify words which have a high probability of leading to sensical sentences or the classifier module itself once partially trained. For example, the classifier module may be trained to infer this quality for candidate words it is presented with by learning to imitate the expert policy.

Multiple different Imitation Learning frameworks may be applicable for use in the classifier module, for example Exact Imitation, Dagger (Ross et al., 2011), SEARN, and Locally Optimal Learning to Search (LOLS). These frameworks may be used individually or in sequential combination with each other. For the presently described example implementation, the classifier may be initiated using a single iteration of Exact Imitation over the full data set, and then the LOLS (Chang et al., 2015), framework may be applied for a number of training iterations until no gain is observed over a development data set.

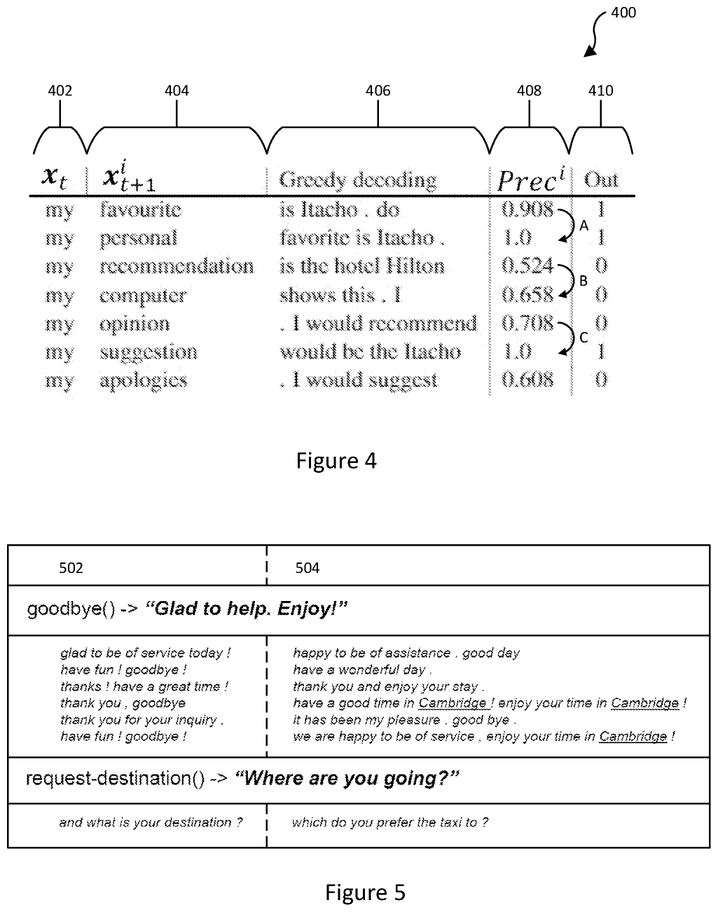

FIG. 4 shows a table illustrating an expert policy inferring a specific training signal from a data set for grammatically correct and fluent phrases. The first column 402 shows the current status xₜ, here the current word is ‘my’. The second column 404 xₜ₊₁ⁱ shows each word of the probability distribution as determined by the underlying NLG logic. The candidate words of the probability distribution are listed in order of descending probability as determined by the NLG. That is, the NLG logic determined ‘favourite’ to be the most likely next word to follow the word ‘my’. The third column 406 shows the result of a greedy decoding performed based on the next word being the candidate word in the second column 404. That is, at each row greedy decoding is used to infer e.g. the next four words, should the word in the second column 404 of that row be selected as the next word in the output. Thus, for the example candidate word ‘favourite’ the greedy decoding process outputs “is Itacho. do”. The fourth column 408 shows a precision value generated based on the determined output which includes the result of the greedy decoding process in the third column 406. This precision is a standard measure, for example a gram precision method. The gram precision method used in this example is a four-gram precision. Any gram value precision may be used to determine the precision value. The selection of which may depend on the processing power of the computer system on which the neural network is being trained and the required speed with which the trained neural network is to be generated. The precision value may be generated by comparing the four terms generated by greedy decoding to sample text in the data set. The expert policy may then determine how well the generated four terms match statement in the data set. The expert policy is formed by an algorithm or set of rules which measure the overlap or precision of the generated phrase (the four terms from the greedy decoding), compared to the training data set. The expert policy may thus be used to train the classifier module in a guided way to learn to infer which words of the probability distribution are worth pursuing and which are not. The fifth column 410 shows the numerical value assigned to the candidate in the second column 404 as a result of the determined precision. This process teaches the neural network to assign a numerical value based on the learned process of determining whether the candidate word should be pursued or not.

To obtain the grammatical specific training signal the expert policy itself must also be defined. In practice, for any given decoder step, the expert policy determines whether a candidate word xₜ₊₁ⁱ is likely to lead to a grammatically correct output by consulting a data set. For the expert policy data set to provide a useful signal, the data set needs to provide a correlation or mapping between the input examples and multiple output examples (i.e. for the same input). For example, in the concept-to-text setting, the data set needs to correlate specific MRs to multiple natural language references. To use the previous example, in a data set the MR [INFORM (REST-NAME=MIZUSHI, OKASAN)] could correlate to the outputs “There are two available restaurants, Mizushi and Okasan” and “Mizushi is an available restaurant nearby. Okasan is another one”.

The expert policy is configured to identify candidate words of a probability distribution which have a high probability of leading to grammatically correct outputs generated from a language generation logic. For example, the method of creating such an expert policy may include receiving a set of candidate words in order of selection strength. That is, the strength with which the words are likely to be selected for use by the language generation logic. This may be simply the order of probability from most likely to least likely as in the probability distribution itself. A candidate phrase may then be formed including lexical elements appropriate to accompany that candidate word of the set, by use of pre-emptive decoding for each candidate word of the set. Finally, each candidate word of the set may be assigned a value indicative of a level of grammatical correctness in dependence on the relative selection strength of that candidate word and the fit of the respective candidate phrase to members of a database of valid phrases. The assigned value may be a numerical value. The selection strength may be the probability of the candidate word being selected as in the probability distribution. The selection strength of any one candidate word may be relative to other candidate words of the probability distribution rather than a numerical value of probability. The fit of the candidate phrase may be a measure of overlap or correspondence of the candidate phrase with references or example phrases in a database or data set of contextually relevant phrases. The candidate phrase may be the result of greedy decoding based on a current state or current word of the decoder and the selected candidate word. The candidate phrase may be referred to herein as a generated sentence or candidate sentence.

During the training of the classifier module, at each decoder step, the expert policy considers the candidate words xₜ₊₁ⁱ in the probability distribution resulting from the decoder cell. To minimise the computational cost, the expert policy may be limited to considering only i∈{0 . . . r}; in this example implementation only the top r=25 words in the decoding distribution may be considered. The top seven of these 25 candidate words are shown in the second column of FIG. 4.

There is a need to examine whether the impact of each candidate word xₜ₊₁ⁱ on the decoding process will lead to a sentence with high grammatical quality. To obtain sentences that are affected by selection of a specific candidate word xₜ₊₁ⁱ, the selection of each candidate word xₜ₊₁ⁱ for step t+1 is forced and the NLG logic is then used to greedily generate the rest of the sentence. The n-gram precision is then calculated for the over-lap for each of the generated sentences between each of the r sentences and a set of references forming the training data. The produced sentences are limited to the previous word xₜ, xₜ₊₁ⁱ, and the next four words x*ₜ₊₂ . . . x*ₜ₊₅ as shown in the third column 406. This is done to make the calculations more consistent between candidate words, but may set to a number of words other than four depending on e.g. the processing power available or a determined acceptable amount of computational cost.

FIG. 4 also shows an example application of the expert policy for the MR of [INFORM (REST-NAME=ITACHO), REQUEST (REST-TYPE)]. The previously selected word xₜ is the same for all examined candidate words xₜ₊₁ⁱ, while the selected words to follow the candidate words xₜ₊₂ xₜ₊₅ may all differ from each other. In this example implementation the n-gram overlap is calculated via a modified 4-gram precision calculation. In this example the calculation is a BLEU-4 score similar to that described in Papineni et al. but modified to remove the brevity penalty. The brevity penalty may be removed in this case since the expert hypotheses are all fixed in size. That is, the generated candidate sentences are all the same number of lexical elements long, where lexical elements include words and punctuation signs, such as full stops and commas. By including this modification, the calculations of the expert policy can be performed in a shorter time period, i.e. the calculations needed to be performed by the expert policy are reduced in complexity. In some methods of calculating a 4-gram precision it is implicit that the precision of 4-grams, 3-grams, bigrams, and unigrams are also calculated. The term gram may be used to refer to any lexical element, including grammatical marks, words, and logograms or characters, etc., depending on the language.

The expert policy may then consider each of the candidate words and their corresponding modified 4-gram precisions “Precᵢ” in ascending i value (i.e. descending probability based on the probability distribution generated by the natural language logic). Each candidate word is considered in turn and assigned a numerical value indicative of a level of grammatical correctness. A particular word xₜ₊₁ⁱ is assumed to lead to a grammatically correct output if the n-gram precision value is larger or equal to the precision value calculated for any previous candidate word xₜ₊₁ⁱ. That is, if the value for the currently considered word, Precᵢ≥max(Prec₀, . . . , Precᵢ₋₁). By using this type of hierarchy based rule and ordering the candidate words based on the language generation logic's probability distribution, it is possible to consider the probability distribution while also assessing the candidate words individually. As a result of the above described method the candidate module may produce a list of candidate words each with a corresponding numerical value (e.g. of 0 or 1) based on the above precision based rule. It should be understood that in this example the expert policy does not output a numerical probability in the mathematical sense, but rather a score that indicates how appropriate each word is. That is, how likely the word is to result in a grammatically correct output which also makes sense. This may not be a perfect process and the expert policy may return a noisy training signal, but many imitation learning frameworks (e.g. LOLS) are designed to learn from suboptimal expert policies.

The fifth column 410 in FIG. 4 shows an example of the numerical values assigned to each candidate word of the second column 404 following the above rule based on the respective Precᵢ value in the fourth column 408. Arrow A shows that given a preceding Precᵢ value of 0.908 for ‘favourite’, a next Precᵢ value of 1 for ‘personal’ will result in an assigned numerical value for ‘personal’ of ‘1’. As the expert policy moves down the list of candidate words in order of selection strength, the resulting candidate phrases are used to calculate precision values for those candidate words. Arrow B shows that even though there is a Precᵢ value of 0.524 for ‘recommendation’, a next Prec₁ value of 0.658 for ‘computer’ will result in an assigned numerical value for both ‘recommendation’ and ‘computer’ of ‘0’. That is, even though the Precᵢ value of ‘computer’ is higher than the Precᵢ value for ‘recommendation’, it is not higher than the Precᵢ value of all preceding candidate words (e.g. the numerical value assigned to ‘personal’). Therefore, following the above rule, ‘computer’ is correctly assigned the numerical value ‘0’ by the expert policy. Arrow C shows that given a preceding Precᵢ value of 0.708 for ‘opinion’, a next Precᵢ value of 1.0 for ‘suggestion’ will result in an assigned numerical value for ‘suggestion’ of ‘1’. ‘Suggestion’ has a Prec₁ value equal to that of the greatest preceding Precᵢ value given for ‘personal’, and is therefore assigned a numerical value of ‘1’ according to the rule stated above, even though it was much less likely to be selected from the probability distribution. Thus, selecting words which correspond to typical vocabulary patterns can be promoted while maintaining grammatical correctness. The numerical value assigned to words further down the probability distribution therefore automatically takes account of the quality of preceding words which have a high selection strength.

The aforementioned reference data sets, which are used in the calculation of the 4-gram precisions Precᵢ, are obtained by decomposing the corresponding MR into its attributes, and then retrieving all the references these attributes correspond to in the data set. For example, for [INFORM (WELCOME); INFORM (BYE)], all references corresponding to any MR containing either INFORM (WELCOME) or INFORM (BYE) are retrieved, e.g. all references corresponding to [INFORM (WELCOME); REQUEST (NAME)] may be retrieved from the data set. In this way data which corresponds to the context of the candidate word or phrase being assessed may be used to form the data set on which the precision assessment is performed.

When using a learning framework such as the LOLS framework to train the classifier module, it may be possible to obtain an additional training signal by using the partially trained classifier module itself. This may be achieved in a similar way to how the expert policy is calculated as described above and shown in FIG. 4. However, instead of greedily generating the subsequent part of the sentence for each candidate word xₜ₊₁ⁱ, the next part of the sentence may be generated by sampling using the partially trained classifier module. In order to allow a broader exploration and to generate a more consistent signal when sampling, multiple hypotheses (potential next parts of the output sentence), are produced and the 4-gram precision values Precᵢ are averaged over those multiple hypotheses. The training signal obtained from the expert policy and the partially trained classifier module may be balanced by initially setting the probability of using the expert policy to p=1.0. That is, it may be set to always obtain the training signal from the expert policy to start with. This probability may be set to exponentially decay, a part of the decay occurring after every training iteration. In this way the reliance on the expert policy may be slowly reduced in favour of the partially trained classifier module as it obtains a greater amount of training.

That is, an imitation learning framework is the method with which the classifier module 304 is trained. To achieve this, the imitation learning method considers the candidate words in the decoder's probability distribution and assigns them appropriateness scores (also referred to herein as a numerical value), based on a training signal received from either the expert policy or the partially trained classifier module itself.

The expert policy may be a dynamic expert policy. A dynamic expert policy is an expert policy which can provide a training signal for any dynamic input. To elaborate, this is different to a static expert policy, which can only provide training signal for states directly encountered in the training data. As a result, the imitation learning framework described herein may be any learning framework that incorporates a dynamic expert policy and is not limited. to an imitation learning framework.

Once the classifier module has been trained, the selection module may be deployed alongside an existing language generation logic or as part of a combined language generation logic and selection module unit. During deployment, when generating a sentence given a specific input, the classifier module is consulted at each decoding step in order to generate a list of candidate words which will lead to a grammatically correct output. When trained and deployed the classifier module 304 does not receive the probability distribution. The candidate words may be extracted from the probability distribution generated by the language generation logic. The candidate words may then be embedded with the natural language logic itself and fed to the classifier module along with the current state.

The list or vector of acceptable candidate words may therefore be sampled with confidence that the generated output will be grammatically correct. The vector may be uniformly sampled to sequentially generate the output text. By using uniform sampling, at every decoding step the language generation logic may select a word equiprobably amongst the acceptable words. Thereby the proposed approach may enable different lexical and structural choices without sacrificing the quality of the output. The candidate words may be selected randomly from the candidate words in the vector because all of them have been determined to be likely to lead to a grammatically correct output. Alternatively, probability sampling may also be performed in this context.

The above described approach may automatically determine acceptable words for providing a level of varied vocabulary that also have a high probability of being grammatically correct from candidate words provided by language generating logic. The above described approach enables the exploitation of a training signal such that selecting words to create a varied vocabulary is less likely to produce disfluent word sequences in the output. The above described approach does not depend on manually tuned parameters and all weights are automatically trained on data. Since the proposed selection module is applied on top of the recurrent decoding process, it can be applied to existing language generation logics without a need to modify how those logics operate.

FIG. 5 shows the results of implementing the above approach in column 502 compared to an existing approach in column 504 for various inputs. It can be seen that the above proposed approach provides high quality outputs. The phrases produced by implementing the selection module of the proposed approach have a more natural structure and are intrinsically less formulaic and formal. Whereas the results from the existing method are stilted in tone, with occasional repetitions of terms, and thus seem unnatural.

For example, given the input [goodbye( )->“Glad to help. Enjoy!”] the fourth candidate phrase of the proposed approach is “thank you, goodbye”. However, the existing method provides the output “Have a good time in Cambridge! Enjoy your time in Cambridge!”. The latter is unnatural not only because of the repetition of “Cambridge”, but also because both sentences convey the same sentiment with no additional information or reason for restating.

Similarly, for the input [request-destination( )->“Where are you going?” ], the proposed approach provides a candidate sentence for output of “and what is your destination?”, whereas an existing approach give a possible output of “which do you prefer the taxi to?”. The approach proposed herein provides a much better quality output in response to this input. The latter suggestion of the existing approach does not make sense and sounds very unnatural. Each word in isolation may credibly follow the previous word in examples of the English language. However, when read together as a statement the series of words is not grammatically correct. This is because previously used methods only exploit the distributions already learned by the NLG model. However, the proposed approach introduces a grammatical correctness and sensical specific learning signal.

The embodiments herein are provided in isolation and each individual feature described herein and any combination of two or more such features, to the extent that such features or combinations are capable of being carried out based on the embodiments as a whole in the light of the common general knowledge of a person of ordinary skill in the art, irrespective of whether such features or combinations of features solve any problems disclosed herein, and without limitation. Aspects of the embodiments may include any such individual feature or combination of features. In view of the foregoing, it is be evident to a person of ordinary skill in the art that various modifications may be made without departing from the scope of the embodiments.

1. A selection module for use in generating a natural language output based on a computer readable input, the selection module comprising:
a classifier module, wherein the classifier module is trained such that when executed alongside a language generation logic the classifier module
receives one of one or more candidate words of a probability distribution and a current state of a decoder in a recurrent decoding process of the language generation logic;
evaluates, based on the current state of the decoder, the received candidate word to determine if the word is likely to lead to a grammatically correct output;
assigns a numerical value indicative of a level of grammatical correctness to the received candidate word; and
outputs the assigned numerical value.

2. The selection module of claim 1, wherein the selection module comprises a candidate module, and the candidate module is configured to:
receive the current state and the one or more candidate words of the probability distribution of the decoder in the recurrent decoding process of the language generation logic;
feed, separately, each one of the one or more candidate words to the classifier module; and
create a vector of acceptable words comprising each of the candidate words to which the classifier module assigned a numerical value indicative of a level of acceptable grammatical correctness.

3. The selection module of claim 2, wherein the candidate module is configured to output the vector of acceptable words to the language generation logic such that only one of the one or more candidate words that also has a high probability of leading to a sensical sentence is chosen at each step of the recurrent decoding process.

4. The selection module of claim 1, wherein the candidate module is configured to feed each of the one of the one or more candidate words to the classifier module in order of descending probability.

5. The selection module of claim 4, wherein the candidate module is configured to stop feeding the one or more candidate words to the classifier module if the classifier module outputs one of the candidate words with an assigned numerical value indicating a level of unacceptable grammatical correctness.

6. The selection module of claim 2, wherein the language generation logic is configured to select the candidate word for the next current state of the decoder by sampling from the vector of acceptable words.

7. The selection module of claim 1, wherein the language generation logic is Natural Language Generator logic, and the output is a string of words forming an utterance expressing the input in natural language.

8. The selection module of claim 7, wherein the Natural Language Generator logic comprises at least one of concept-to-text, context-to-text, or text-to-text Natural Language Generator logic.

9. The selection module of claim 1, wherein each word of the candidate words is defined for input to the classifier module according to the equation:
c=[hₜ,tan h(W_{dc}dₜ),W_{wr}xₜ₊₁ⁱ,W_{wr}xₜ₋₂,W_{wr}xₜ₋₁,W_{wr}xₜ],
wherein W_{wr} is a word embedding weight matrix, W_{dc} is an input representation weight matrix, xₜ is a word at step t, hₜ is a hidden state of the decoder at step t, dₜ is an input vector representation, and xₜ₊₁ⁱ is an i-th word of the decoding distribution for the next step t+1.

10. The selection module of claim 1, wherein the numerical value indicative of a level of grammatical correctness is selected from 1 or 0, wherein 1 indicates an acceptable level and 0 indicates an unacceptable level.

11. A method of training a classifier module comprising a trained artificial intelligence model for execution alongside a language generation logic such that a word with a high probability of leading to a sensical sentence is chosen at each decoder step of a recurrent decoding process of the language generation logic, the method comprising:
receiving an example candidate word of a probability distribution of one decoder step of said language generation logic; and
training the classifier module using imitation learning, based on the example candidate word and either an expert policy configured to identify words which have a high probability of leading to sensical sentences or the classifier module when partially trained, to determine the likelihood a candidate word will lead to a sentence which has an acceptable level of grammatical correctness and to assigning a numerical value to the candidate word indicative of the level of grammatical correctness.

12. The method according to claim 11, wherein framework for the imitation learning comprises at least one of LOLS, Dagger, SEARN, or Exact Imitation.

13. A method of creating an expert policy configured to identify candidate words of a probability distribution which have a high probability of leading to grammatically correct outputs from a language generation logic, the method comprising:
receiving a set of the candidate words in order of selection strength;
forming, through pre-emptive decoding for each candidate word of the set, a candidate phrase comprising lexical elements appropriate to accompany that candidate word of the set; and
assigning to each candidate word of the set a value indicative of a level of grammatical correctness in dependence on the relative selection strength of that candidate word and the fit of the respective candidate phrase to members of a database of valid phrases.

14. The method according to claim 13, wherein the value assigned to the candidate word is:
0 if the fit of the candidate phrase formed for said candidate word is worse than any preceding candidate word in the set; or
1 and if the fit of the candidate phrase formed for said candidate word is better than any preceding candidate word in the set.

15. The method according to claim 13, wherein the fit is measured using an n-gram precision calculation.
